(19) United States
(12) Patent Application Publication
(10) Pub. No.: US 2017/0130862 A1
(43) Pub. Date: May 11, 2017

(54) PRESSURE REDUCING VALVE

(71) Applicant: AISAN KOGYO KABUSHIKI KAISHA, Obu-shi (JP)

(72) Inventors: Masahiro KOBAYASHI, Toyohashi-shi (JP); Mitsuyoshi ITAHARA, Obu-shi (JP); Hideyuki FUKUDA, Nagoya-shi (JP); Takehide NAKAMURA, Handa-shi (JP); Hirofumi HASHIBA, Obu-shi (JP); Seitaro ITO, Anjo-shi (JP); Sumito TAKEDA, Nagoya-shi (JP); Hiroshi KAWAZOE, Kariya-shi (JP)

(73) Assignee: AISAN KOGYO KABUSHIKI KAISHA, Obu-shi (JP)

(21) Appl. No.: 15/336,105

(22) Filed: Oct. 27, 2016

(30) Foreign Application Priority Data
Nov. 10, 2015 (JP) 2015-220090

(51) Int. Cl. F16K 31/122; G05D 16/10; F16K 27/02

(52) U.S. Cl. CPC F16K 31/1221; F16K 27/02; G05D 16/106

(57) ABSTRACT

A pressure reducing valve includes a valve seat, a valve element configured to contact with or separate from the valve seat to close or open a flow passage, a piston to move the valve element into or out of contact with the valve seat, and a spring urging the piston in a valve opening direction of the valve element. The pressure reducing valve further includes a rattling prevention part for preventing rattling which may occur between the piston and the spring due to unevenness of a polished surface of the spring.

### CROSS-REFERENCE TO RELATED APPLICATIONS

This application is based upon and claims the benefit of priority from the prior Japanese Patent Application No. 2015-220090, filed Nov. 10, 2015, the entire contents of which are incorporated herein by reference.

### BACKGROUND

Technical Field

The present invention relates to a pressure reducing valve for regulating for example the pressure of fuel gas to be supplied from a fuel tank to a supply destination to desired pressure by reducing the pressure.

Related Art

Patent Document 1 discloses a pressure reducing valve including a cylinder, a piston movable within the cylinder, a valve mechanism to be opened or closed in synchronization with movement of the piston, and a spring that urges the piston in a valve opening direction of the valve mechanism.

### RELATED ART DOCUMENTS

### Patent Documents

Patent Document 1: Japanese unexamined patent application publication No. 2014-96094

### SUMMARY

### Technical Problems

In the pressure regulating valve disclosed in Patent Document 1, oscillation of the piston may be caused by pressure variation in a pressure regulating chamber.

The present invention has been made to solve the above problems and has a purpose to provide a pressure reducing valve capable of preventing a piston from oscillating.

### Means of Solving the Problems

To achieve the above purpose, one aspect of the invention provides a pressure reducing valve comprising: a valve seat; a valve element configured to contact with and separate from the valve seat to close and open a flow passage; a piston configured to cause the valve element to contact with and separate from the valve seat; and a spring urging the piston in a valve opening direction of the valve element, the pressure reducing valve being configured to regulate pressure of a fluid flowing in the flow passage, wherein the pressure reducing valve further comprises a rattling prevention part configured to suppress rattling between the piston and the spring due to unevenness of an end face of the spring, the end face being located at one end in a central axis direction of the spring.

The above configuration can suppress rattling, which may occur between the piston and the spring, and thus can prevent the piston from oscillating.

To achieve the above purpose, another aspect of the invention provides a pressure reducing valve comprising: a valve seat; a valve element configured to contact with and separate from the valve seat to close and open a flow passage; a piston configured to cause the valve element to contact with and separate from the valve seat; and a spring urging the piston in a valve opening direction of the valve element, the pressure reducing valve being configured to regulate pressure of a fluid flowing in the flow passage, wherein the piston and the spring are fixed to each other.

In the above configuration, the piston and the spring are fixed to each other, so that the rattling between the piston and the spring is suppressed. Thus, the piston can be prevented from oscillating.

To achieve the above purpose, still another aspect of the invention provides a pressure reducing valve comprising: a valve seat; a valve element configured to contact with and separate from the valve seat to close and open a flow passage; a piston configured to cause the valve element to contact with and separate from the valve seat; and a spring urging the piston in a valve opening direction of the valve element, the pressure reducing valve being configured to regulate pressure of a fluid flowing in the flow passage, wherein the pressure reducing valve further comprises: a pressure-regulating chamber formed on a downstream side of the valve seat in a flow direction of a fluid so that pressure of the fluid is regulated in the pressure-regulating chamber; and a flow-direction fixing part configured to fix a flow direction of the fluid to a predetermined fixed direction when the fluid flows in the pressure-regulating chamber.

With the above configuration, the direction of a flow passage of a fluid in the pressure-regulating chamber can be fixed, or limited, to one direction. Thus, the flow direction of the fluid in the pressure-regulating chamber is made stable, so that rattling between the piston and the spring is suppressed. Thus, the piston can be prevented from oscillating.

To achieve the above purpose, another aspect of the invention provides a pressure reducing valve comprising: a valve seat; a valve element configured to contact with and separate from the valve seat to close and open a flow passage; a piston configured to cause the valve element to contact with and separate from the valve seat; and a spring urging the piston in a valve opening direction of the valve element, the pressure reducing valve being configured to regulate pressure of a fluid flowing in the flow passage, wherein the valve element is integral with the piston, and the pressure reducing valve further comprises a valve element urging member placed in a position displaced from a central axis of the valve element in a radial direction of the valve element and configured to urge a part of the valve element in its circumferential direction to a valve opening direction.

In the above configuration, the valve element is always pressed on one side in the radial direction of the valve element by an urging force of the valve element urging member. Accordingly, the valve element is less likely to oscillate or vibrate back and forth in the radial direction of the valve element and therefore rattling between the piston integral with the valve element and the spring is suppressed. Thus, the piston can be prevented from oscillating.

To achieve the above purpose, another aspect of the invention provides a pressure reducing valve comprising: a valve seat; a valve element configured to contact with and separate from the valve seat to close and open a flow passage; a piston configured to cause the valve element to contact with and separate from the valve seat; and a spring urging the piston in a valve opening direction of the valve element, the pressure reducing valve being configured to regulate pressure of a fluid flowing in the flow passage, wherein the pressure reducing valve further comprises a piston urging member placed in a position displaced from a central axis of the piston in a radial direction of the piston and configured to urge a part of the piston in its circumferential direction to a direction opposite to an urging direction of the spring.

In the above embodiment, the piston is always pressed on one side in the radial direction of the piston by an urging force of the piston urging member. Accordingly, the piston is less likely to oscillate or vibrate back and forth in the radial direction of the piston. The piston is suppressed from oscillating or vibrating.

### BRIEF DESCRIPTION OF THE DRAWINGS

FIG. 1 is a cross sectional view of a pressure reducing valve in Example 1 of a first embodiment;

FIG. 2 is an enlarged cross sectional view of a spring seat of a piston and its surrounding part in FIG. 1;

FIG. 3 is a cross sectional view taken along a line A-A in FIG. 2;

FIG. 4 is a cross sectional view taken along a line B-B in FIG. 2;

FIG. 5 is an enlarged cross sectional view of a retaining part of a piston and its surrounding part in Example 2 of the first embodiment;

FIG. 6 is an enlarged cross sectional view of a spring seat of a piston in Example 3 of the first embodiment;

FIG. 7 is an enlarged cross sectional view of a valve element and its surrounding part in Example 1 of a second embodiment;

FIG. 8 is a top view of the valve element in Example 1 of the second embodiment;

FIG. 9 is an enlarged cross sectional view of a valve element and its surrounding part in Example 2 of the second embodiment;

FIG. 10 is an enlarged cross sectional view of a valve element and its surrounding part in Example 3 of the second embodiment;

FIG. 11 is an enlarged cross sectional view of a valve element and its surrounding part in Example 1 of a third embodiment; and

FIG. 12 is an enlarged cross sectional view of a second pressure-regulating chamber and its surrounding part in Example 2 of the third embodiment.

### DESCRIPTION OF EMBODIMENTS

### First Embodiment

Example 1

A detailed description of a preferred first embodiment of a pressure reducing valve 1 will now be given referring to the accompanying drawings. In the following description, an “upstream side” represents an upstream side in a flow direction of fuel gas G and a “downstream side” indicates a downstream side in the flow direction of fuel gas G.

The pressure reducing valve 1 is a valve for regulating the pressure of fuel gas G to desired pressure by reducing the fuel gas pressure. The fuel gas G is for example hydrogen gas to be supplied to a fuel battery or cell (not shown). An upstream end of the pressure reducing valve 1 is connected to a main stop valve (not shown) for supplying or stopping the fuel gas G stored in a fuel tank (not shown). A downstream end of the pressure reducing valve 1 is connected to an injector (not shown) for supplying the fuel gas G to the fuel battery or cell.

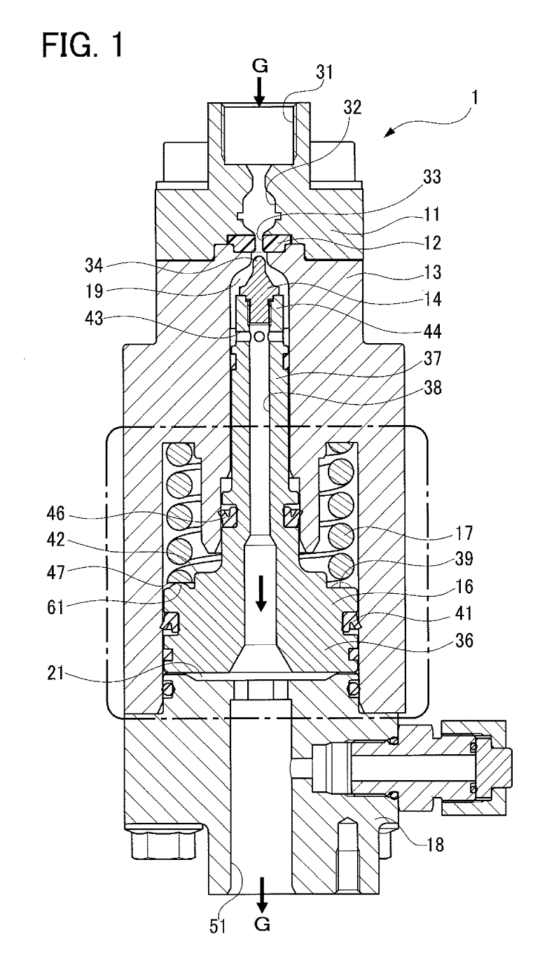

The pressure reducing valve 1 includes, as shown in FIG. 1, an inlet block member 11, a valve seat 12, a body member 13, a valve element 14, a piston 16, a spring 17, an outlet block member 18, and others. The body member 13 is internally formed with a first pressure-regulating chamber 19. Further, a second pressure-regulating chamber 21 is defined by the body member 13, the piston 16, and the outlet block member 18.

The inlet block member 11 is provided with an inlet 31, an inlet passage 32, and others. The inlet 31 is an inflow port through which fuel gas G flows in the pressure reducing valve 1. The inlet passage 32 is a passage communicated with the inlet 31 and a through hole 33 of the valve seat 12.

The valve seat 12 is sandwiched between the inlet block member 11 and the body member 13. The valve seat 12 has a substantially circular ring shape. The valve seat 12 is provided with a through hole 33 communicated with the inlet passage 32 and the first pressure-regulating chamber 19.

The body member 13 is a housing of the pressure reducing valve 1, internally housing the valve element 14, the piston 16, the spring 17, and a part of the outlet block member 18.

The valve element 14 is placed in the first pressure-regulating chamber 19 on a downstream side of the valve seat 12. The valve element 14 includes a substantially columnar end portion 34 on a side toward the valve seat 12. The valve element 14 is moved within the first pressure-regulating chamber 19 so that the end portion 34 contacts with or separates from the valve seat 12, thereby shutting off or allowing a flow of the fuel gas G. Specifically, the valve element 14 is configured to open and close a flow passage communicated with the through hole 33 of the valve seat 12 and the first pressure-regulating chamber 19. The valve element 14 is attached to an end portion 44 of the piston 16 so that the valve element 14 is placed integrally with the piston 16.

The piston 16 includes a main part 36, a rod-like part 37, a passage 38, and others. The main part 36 has a cylindrical shape. This main part 36 is placed in a position downstream of the rod-like part 37. The main part 36 includes, on a surface on a side toward the spring 17, a spring seat 39 (a contact portion contacting with the spring 17) with which a polished surface 47 of the spring 17 contacts. On an outer peripheral surface of the main part 36, a seal member 41 is mounted.

The rod-like part 37 has a cylindrical shape. This rod-like part 37 is placed on an upstream side of the main part 36. The rod-like part 37 includes a retaining part 42, inflow holes 43, and others. The retaining part 42 is formed in a joint section between the rod-like part 37 and the main part 36. The retaining part 42 is a cylindrical protruding part that protrudes from the spring seat 39 in a direction along a central axis (i.e., a central axis direction) of the spring 17. This retaining part 42 serves to limit the position of the spring 17. The passage 38 is formed extending through the piston 16 in a central axis direction of the piston 16. In the end portion 44 on the upstream side (the side toward the valve seat 12) of the rod-like part 37, the valve element 14 is placed so that a part of the valve element 14 (a lower part in FIG. 1) is inserted in the passage 38 for example by threaded engagement. In this manner, the piston 16 is provided integral with the valve element 14 to cause the valve element 14 to contact with and separate from the valve seat 12. In an outer peripheral surface of the rod-like part 37, a seal member 46 is mounted.

In the present example, a plurality of protrusions 61 are formed on the spring seat 39. The details of these protrusions 61 will be described later.

The spring 17 is placed between the body member 13 and the piston 16. The spring 17 urges the piston 16 in a direction toward the outlet block member 18, that is, in a valve opening direction of the valve element 14 (i.e., in a direction away from the valve seat 12).

In the present example, as shown in FIGS. 1, 2, and 4, the spring 17 includes the polished surface 47, a recessed portion 48, and others. The polished surface 47 is an end face of the spring 17 at one end in the central axis direction, which is an end face contacting the spring seat 39 of the piston 16 in the present example. This is a surface polished into a flat surface. The spring 17 made of a spirally wound wire is formed with the recessed portion 48 as a concavely curved portion in a boundary area between a first turn and a second turn of the wire from the polished surface 47 side so that a the wire of the second turn extends beyond a winding end portion 49 of the first turn (on an upper side in FIG. 1 and a back side in FIG. 4).

The outlet block member 18 has an outlet 51. This outlet 51 is an outflow port through which fuel gas G flows out of the pressure reducing valve 1.

The first pressure-regulating chamber 19 is formed in a position downstream of the valve seat 12. This first pressure-regulating chamber 19 is brought into communication with the inlet 31 of the inlet block member 11 through the through hole 33 of the valve seat 12 when the valve element 14 separates from the valve seat 12.

The second pressure-regulating chamber 21 is formed in a position downstream of the piston 16. This second pressure-regulating chamber 21 is defined by the body member 13, the piston 16, and the outlet block member 18.

In each of the first pressure-regulating chamber 19 and the second pressure-regulating chamber 21, the pressure of the fuel gas G is regulated. The pressure reducing valve 1 in the present example is configured as above.

Next, operations (an operating method) of the pressure reducing valve 1 in the present example will be described below. For instance, when the fuel gas G starts to be supplied to a vehicle fuel battery and therefore flows out in the direction (in the central axis direction of the piston) indicated by arrows through the outlet 51, as shown in FIG. 1, the pressure of the fuel gas G stored in the second pressure-regulating chamber 21 decreases. The piston 16 is thus moved toward the outlet block member 18 by the urging force of the spring 17, thereby causing the valve element 14 integral with the piston 16 to separate from the valve seat 12. Thus, high-pressure fuel gas G supplied from a fuel tank is allowed to flow through the inlet 31, the inlet passage 32, and the through hole 33 of the valve seat 12 into the first pressure-regulating chamber 19. Furthermore, the fuel gas G flowing in the first pressure-regulating chamber 19 then flows through the inflow holes 43 and the passage 38 of the piston 16 into the second pressure-regulating chamber 21.

After that, when the pressure of the fuel gas G in the second pressure-regulating chamber 21 rises and therefore the force by the pressure of the fuel gas G acting on the piston 16 increases more than the urging force of the spring 17, the piston 16 is moved toward the valve seat 12 against the urging force of the spring 17. Then, the valve element 14 integral with the piston 16 comes into contact with the valve seat 12, thereby stopping the fuel gas G from flowing in the first pressure-regulating chamber 19 and the second pressure-regulating chamber 21. In this way, the pressure of the fuel gas G throughout the first pressure-regulating chamber 19 and the second pressure-regulating chamber 21 is maintained at a predetermined value. To be concrete, the pressure in the first pressure-regulating chamber 19 and the second pressure-regulating chamber 21 is adjusted so that a force obtained by multiplying the pressure in the second pressure-regulating chamber 21 by the diameter of the second pressure-regulating chamber 21 sealed by the seal member 41 is equal to the urging force of the spring 17. The operations of the pressure reducing valve 1 in the present example are as described above.

Herein, the polished surface 47 of the spring 17 is not a completely flat surface and is uneven or undulated. Therefore, non-contact areas are present between the spring seat 39 of the piston 16 and the polished surface 47 of the spring 17. Accordingly, the piston 16 is likely to rattle with respect to the spring 17. Therefore, for example, during valve opening of the pressure reducing valve 1 (while the valve element 14 is separated from the valve seat 12), the piston 16 (and the valve element 14 integral with the piston 16) may be oscillated in resonance with the frequency of the vortices created in the flow streams of fuel gas G flowing in the first pressure-regulating chamber 19 and the second pressure-regulating chamber 21. In association with the oscillation of the piston 16 caused as above, a pressure-regulating value of the fuel gas G may pulsate and generate a sound. Since the spring 17 includes the recessed portion 48 concavely curved as described above, the piston 16 is apt to rattle with respect to the spring 17 and may oscillate. For this purpose, the present embodiment takes measures as below to prevent the piston 16 from oscillating.

In the present embodiment, the pressure reducing valve 1 includes a rattling prevention part for preventing rattling or slip, which may occur between the piston 16 and the spring 17 due to unevenness of the polished surface 47 of the spring 17.

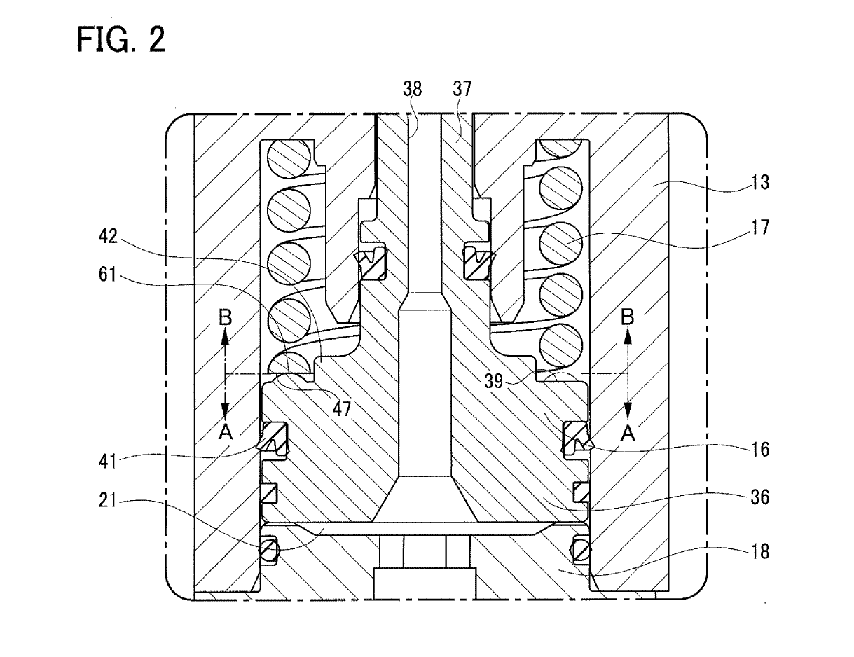

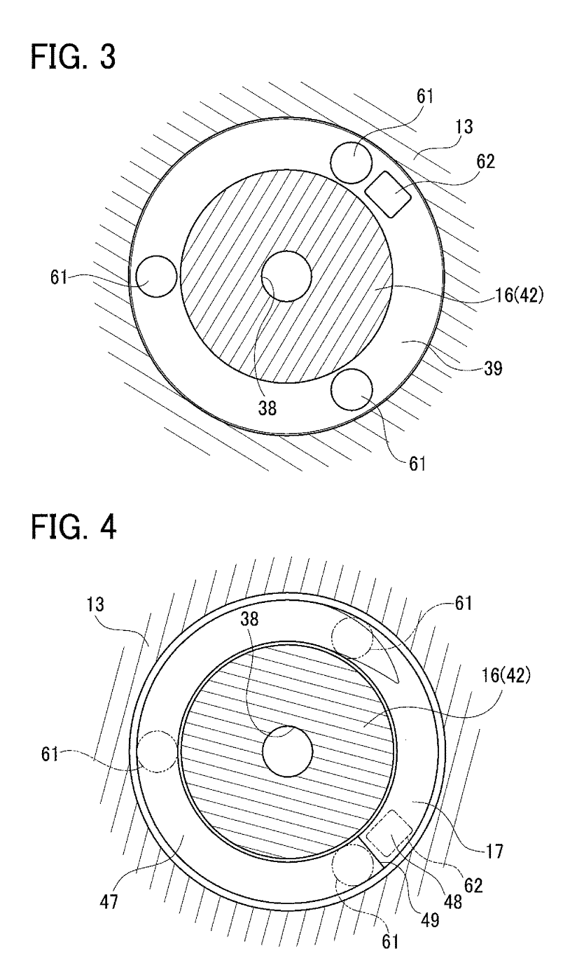

In the present example (Example 1 of the first embodiment), concretely, the piston 16 is provided, on the spring seat 39, with the protrusions 61 as one example of the rattling prevention part, as shown in FIG. 2. The protrusions 61 protrude from the spring seat 39 toward the spring 17. As shown in FIGS. 3 and 4, the protrusions 61 are formed at three places. More concretely, three protrusions 61 are arranged in a circumferential direction of the spring 17 (i.e., in a circumferential direction of the piston 16) at predetermined intervals, for example, at equal intervals with a central angle of 120° in the present example. Further, all of the three protrusions 61 are in contact with the polished surface 47.

Further, as shown in FIGS. 3 and 4, the piston 16 is provided, on the spring seat 39, with a convex portion 62 used for positioning. This convex portion 62 protrudes from the spring seat 39 toward the spring 17. The convex portion 62 is placed in correspondence with the recessed portion 48 of the spring 17. Accordingly, the piston 16 and the spring 17 are placed in position in the circumferential direction.

According to the present example, the pressure reducing valve 1 includes three protrusions 61 equally spaced in the circumferential direction of the spring 17 as one example of the rattling prevention part on the spring seat 39 of the piston 16.

With the above configuration, the piston 16 and the spring 17 can be stably held in contact relation. This enables preventing rattling which may occur between the piston 16 and the spring 17. Thus, the piston 16 is prevented from oscillating or vibrating. This can avoid pulsation of the pressure regulating value of the fuel gas G and hence prevent the generation of a sound.

In the present example, the fuel gas G having undergone pressure regulation in the first and second pressure-regulating chambers 19 and 21 flows in the central axis direction of the piston 16 and is discharged out through the outlet 51. Accordingly, oscillation of the piston 16 is less caused by the pressure of the fuel gas G having been subjected to pressure regulation. This enables preventing rattling which may occur between the piston 16 and the spring 17. Thus, the piston 16 is prevented from oscillating or vibrating.

Example 2

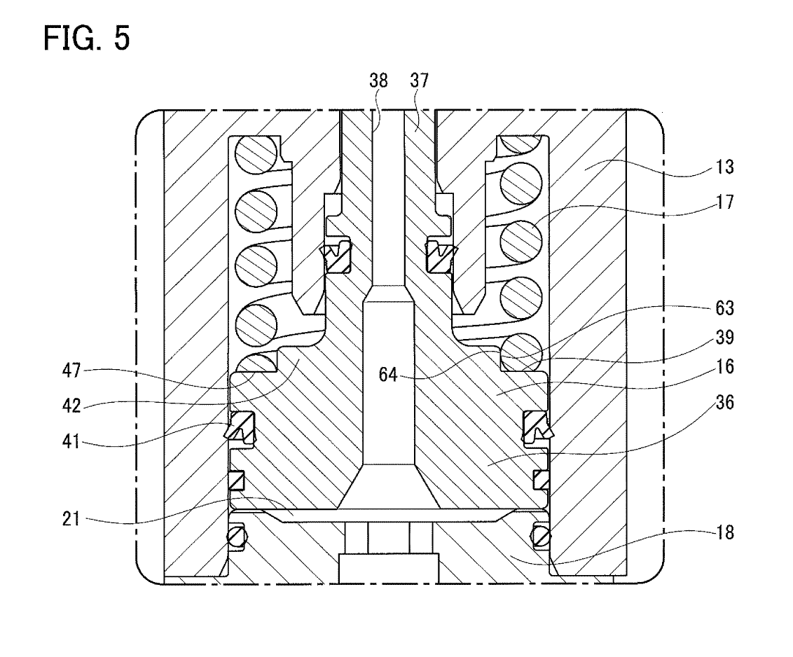

Next, Example 2 of the first embodiment will be described below. In this example, the diameter of the outer peripheral surface 63 of the retaining part 42 of the piston 16 is designed larger than the diameter of the inner circumferential portion 64 of the spring 17. Accordingly, the piston 16 and the spring 17 are fixed to each other in such a manner that the inner circumferential portion 64 of the spring 17 is press-fit on the outer peripheral surface 63 of the retaining portion 42 of the piston 16 as shown in FIG. 5. A protruding amount of the retaining portion 42 of the piston 16 from the spring seat 39 is determined to an amount that does not reach the position of the second turn of the spirally wound wire constituting the spring 17 from the polished surface 47 side.

According to the present example, the piston 16 and the spring 17 are fixedly connected to each other by press-fitting of the inner circumferential portion 64 of the spring 17 on the outer peripheral surface 63 of the retaining portion 42 of the piston 16. This enables suppressing the rattling which may occur between the piston 16 and the spring 17. Thus, the piston 16 is prevented from oscillating or vibrating.

Example 3

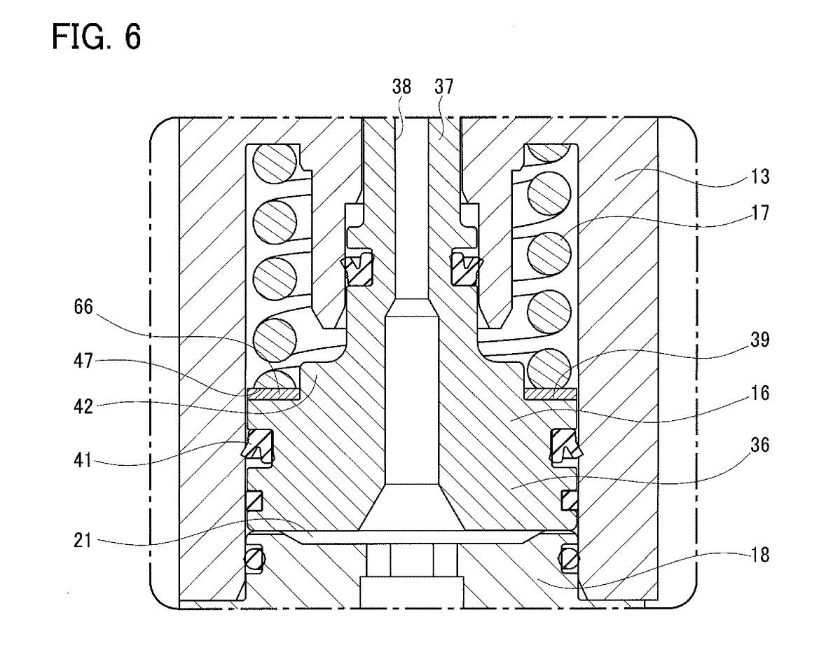

Example 3 of the first embodiment will be described below. In this example, as shown in FIG. 6, the spring 17 is provided with a metal plate 66 fixed to the polished surface 47 by welding. This metal plate 66 is one example of the rattling prevention part. Specifically, the metal plate 66 is a circular flat ring plate having an outer diameter equal or almost equal to the outer diameter of the spring 17.

According to the present example, the pressure reducing valve 1 includes the metal plate 66 as one example of the rattling prevention part, fixed to the polished surface 47 of the spring 17. Thus, the piston 16 and the spring 17 can be stably held in contact relation through the metal plate 66. This enables preventing rattling which may occur between the piston 16 and the spring 17. Thus, the piston 16 is prevented from oscillating or vibrating.

### Second Embodiment

A second embodiment will be described below. In the following description, identical or similar parts to those in the first embodiment are explained with the same reference signs as those in the first embodiment. The following description is therefore given with a focus on differences from the first embodiment.

Example 1

Example 1 of the second embodiment will be first described. In this example, the pressure reducing valve 1 includes a flow-direction fixing part for fixing, or limiting, the flow direction of fuel gas G to a predetermined direction when the fuel gas G flows in the first pressure-regulating chamber 19 through the through hole 33 of the valve seat 12.

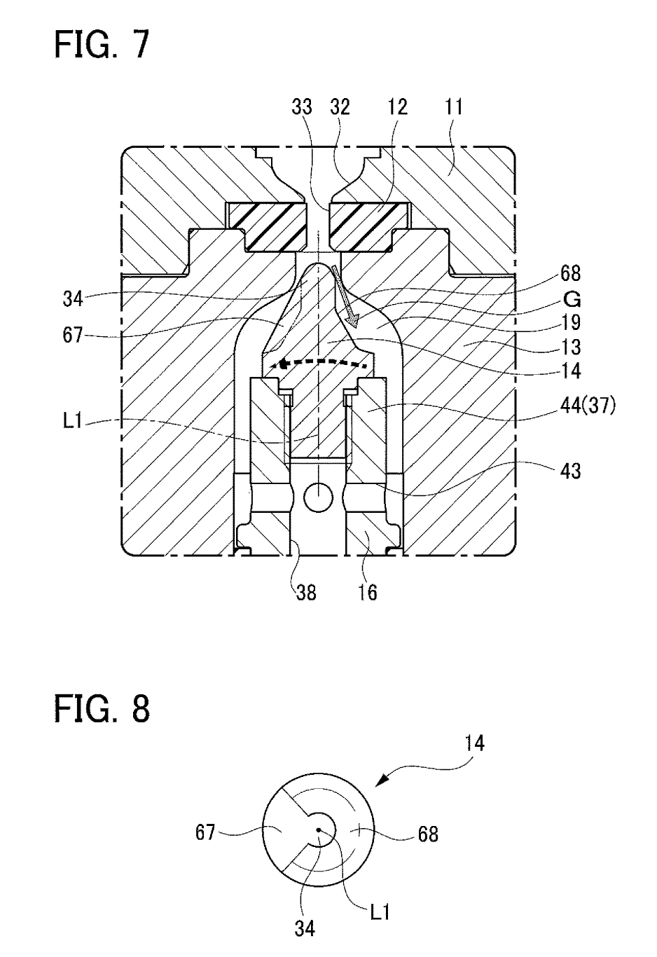

In the present example, concretely, the pressure reducing valve 1 includes the valve element 14 configured as shown in FIGS. 7 and 8 as one example of the flow-direction fixing part. As shown in FIGS. 7 and 8, the valve element 14 is designed in an asymmetrical shape about a central axis L1 of the valve element 14 and includes a thick portion 67 in a part in a circumferential direction of the valve element 14. The thick portion 67 is thicker than a portion 68 other than the thick portion 67 in the valve element 14. Specifically, the thick portion 67 is designed such that a distance (thickness) from the central axis L1 of the valve element 14 to the outer peripheral surface is longer than a distance of the regular portion 68. As shown in FIG. 7, the valve element 14 in this example includes an increased thickness portion on one side in a radial direction of the valve element 14 as compared with the valve element 14 in the first embodiment. It is to be noted that the thick portion 67 is preferably formed in a range from 120° to 180° in the circumferential direction of the valve element 14.

According to the present example, the valve element 14 is designed in an asymmetrical shape about the central axis L1 and includes the thick portion 67 in a part in the circumferential direction of the valve element 14.

During valve opening of the pressure reducing valve 1 in which the valve element 14 is separated from the valve seat 12, consequently, the fuel gas G flowing in the first pressure-regulating chamber 19 is less likely to flow in an area where the thick portion 67 of the valve element 14 is located, while the fuel gas G is more likely to flow in an area where the thick portion 67 is not placed. In the above manner, the flow direction of the fuel gas G flowing in the first pressure-regulating chamber 19 can be fixed to a predetermined direction, that is, a direction in which the thick portion 67 of the valve element 14 is absent. In other words, the direction of a flow passage of fuel gas G in the first pressure-regulating chamber 19 can be fixed to one direction (a right side of the valve element 14 in FIG. 7). Therefore, the direction of pressure of the fuel gas G acting on the valve element 14 is limited to a given direction, so that oscillation of the valve element 14 integral with the piston 16 is less caused by the pressure of the fuel gas G. This enables preventing rattling which may occur between the piston 16 and the spring 17. Thus, the piston 16 is prevented from oscillating.

Example 2

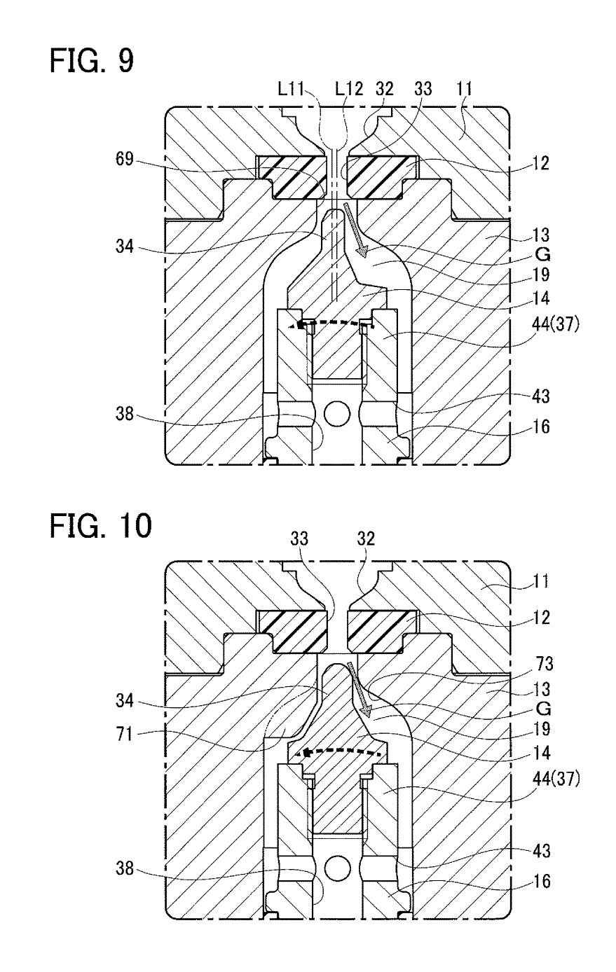

Example 2 of the second embodiment will be described below. In this example, the pressure reducing valve 1 includes the valve element 14 configured as shown in FIG. 9 as one example of the flow-direction fixing part. In the present example, as shown in FIG. 9, the central axis L11 of the end portion 34 of the valve element 14 on the side toward the valve seat 12 is displaced from the central axis L12 of the inlet 69 of the first pressure-regulating chamber 19 in a radial direction of the inlet 69 of the first pressure-regulating chamber 19. Herein, the inlet 69 of the first pressure-regulating chamber 19 is an inflow port formed in a cylindrical shape, through which the fuel gas G flows in the first pressure-regulating chamber 19.

According to the present example, the position of the central axis L11 of the end portion 34 of the valve element 14 on the side toward the valve seat 12 is displaced from the position of the central axis L12 of the inlet 69 of the first pressure-regulating chamber 19 in the radial direction of the inlet 69 of the first pressure-regulating chamber 19. Thus, when flowing in the first pressure-regulating chamber 19, the fuel gas G is less likely to flow in an area (a left side of the valve element 14 in FIG. 9) to which the central axis L11 of the end portion 34 of the valve element 14 is displaced, while the fuel gas G readily flows in an opposite area (a right side of the valve element 14 in FIG. 9) to the former area. In this manner, the flow direction of the fuel gas G allowed to flow in the first pressure-regulating chamber 19 is fixed, or limited, to a predetermined direction, that is, to a direction toward the latter area opposite the former area to which the central axis L11 of the end portion 34 of the valve element 14 is displaced. Accordingly, the direction of the pressure of fuel gas G acting on the valve element 14 is fixed to a given direction, oscillation of the valve element 14 integral with the piston 16 is less caused by the pressure of the fuel gas G. This enables preventing rattling which may occur between the piston 16 and the spring 17. Thus, the piston 16 is prevented from oscillating or vibrating.

Example 3

Example 3 of the second embodiment will be described later. In the present example, the pressure reducing valve 1 includes the body member 13 configured as shown in FIG. 10 as one example of the flow-direction fixing part. In the present example, as shown in FIG. 10, the body member 13 is provided with a protruding portion 71 protruding inward in the first pressure-regulating chamber 19.

According to the present example, the body member 13 includes the protruding portion 71 formed protruding inward from a part of an inner peripheral surface of the first pressure-regulating chamber 19. This protruding portion 71 has a contour corresponding to the outer shape of the valve element 14 as shown in FIG. 10 and thus restricts the valve element 14 from tilting to one side in the radial direction of the first pressure-regulating chamber 19. Accordingly, the valve element 14 is unlikely to tilt to one side in the radial direction of the first pressure-regulating chamber 19. Thus, oscillation of the valve element 14 integral with the piston 16 is less caused. This enables preventing rattling which may occur between the piston 16 and the spring 17. Thus, the piston 16 is prevented from oscillating or vibrating.

Further, the fuel gas G flowing in the first pressure-regulating chamber 19 is less likely to flow in an area where the protruding portion 71 is located, while the fuel gas G is more likely to flow in an area where the protruding portion 71 is not placed. In this manner, the flow direction of the fuel gas G flowing in the first pressure-regulating chamber 19 can be fixed to a predetermined direction, that is, a direction in which the protruding portion 71 is absent. In other words, the direction of pressure of the fuel gas G acting on the valve element 14 can be fixed to a given direction. Accordingly, oscillation of the valve element 14 integral with the piston 16 is less caused by the pressure of the fuel gas G. This enables preventing rattling which may occur between the piston 16 and the spring 17. Thus, the piston 16 is prevented from oscillating or vibrating.

According to the present example, any work for positioning the valve element 14 and the piston 16 in the circumferential direction (rotational direction) is unnecessary. This results in improvement of assembling property of the pressure reducing valve 1.

### Third Embodiment

A third embodiment will be described below. Identical or similar parts to those in the first or second embodiment are explained with the same reference signs as those in the first or second embodiment. The following description is therefore given with a focus on differences from the first and second embodiments.

Example 1

Example 1 of the third embodiment will be described first. In this example, the pressure reducing valve 1 includes a spring 72 (one example of a valve element urging member).

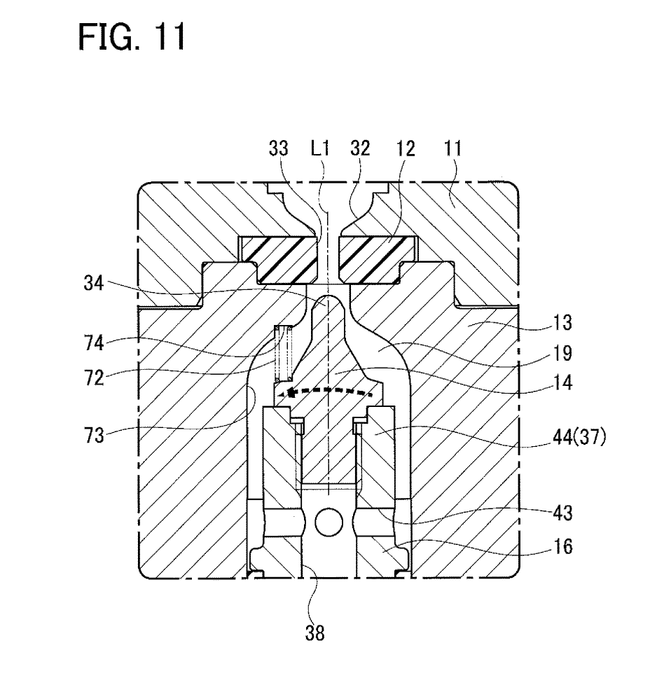

As shown in FIG. 11, the spring 72 is placed between the valve element 14 and a spot facing portion 74 of an inner peripheral surface 73 defining the first pressure-regulating chamber 19 of the body member 13. This spring 72 is placed at a position displaced from the central axis L1 of the valve element 14 in the radial direction of the valve element 14. The spring 72 urges a part of the valve element 14 in its circumferential direction to a valve opening direction.

According to the present example, the spring 72 whereby a part of the valve element 14 in the circumferential direction is urged in the valve opening direction is placed at the position displaced from the central axis L1 of the valve element 14 in the radial direction of the valve element 14. Accordingly, under the urging force of the spring 72, the valve element 14 is always pressed against the piston 16 on one side of the valve element 14 (as indicated by an arrow in FIG. 11) in the radial direction of the valve element 14. Thus, the valve element 14 integral with the piston 16 is less likely to oscillate or vibrate to either side in the radial direction of the valve element 14. This enables preventing rattling which may occur between the piston 16 and the spring 17. Thus, the piston 16 is prevented from oscillating or vibrating.

Example 2

Example 2 of the third embodiment will be described below. In this example, the pressure reducing valve 1 includes a spring 76 (one example of a piston urging member).

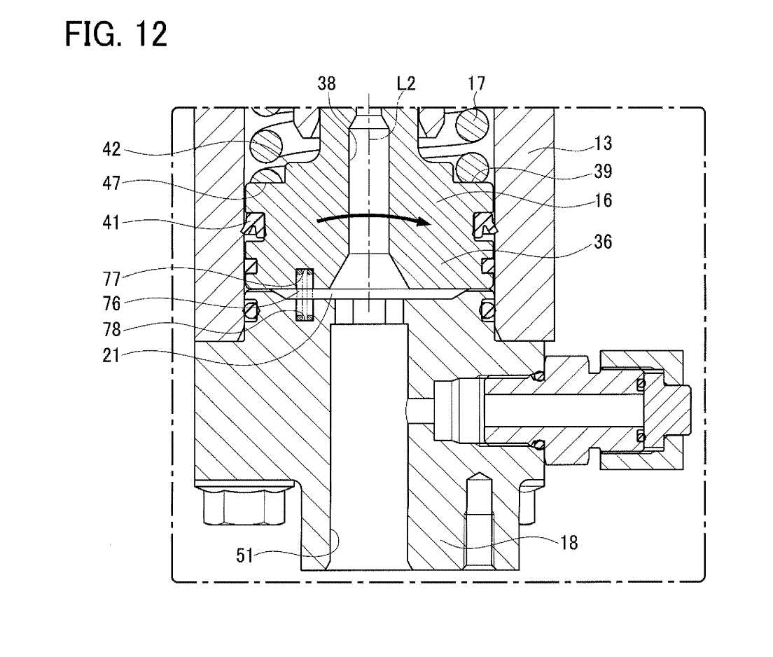

As shown in FIG. 12, the spring 76 is placed between a spot facing portion 77 of the piston 16 and a spot facing portion 78 of the outlet block member 18 and at a position displaced from the central axis L2 of the piston 16 in the radial direction of the piston 16. This spring 76 urges a part of the piston 16 in a circumferential direction to a direction (a valve closing direction) opposite to the urging direction of the spring 17.

According to the present example, the spring 76 whereby a part of the piston 16 in the circumferential direction is urged in the opposite direction to the urging direction of the spring 17 is placed at the position displaced from the central axis L2 of the piston 16 in the radial direction of the piston 16. Accordingly, the urging force of the spring 76 causes the piston 16 to be always pressed, or held down, on one side of the piston 16 (as indicated by an arrow in FIG. 12) in the radial direction of the piston 16. Thus, the piston 16 is less likely to oscillate or vibrate to either side in the radial direction of the piston 16. This enables preventing rattling which may occur between the piston 16 and the spring 17. Thus, the piston 16 is prevented from oscillating or vibrating.

The foregoing embodiments are mere examples and give no limitation to the present invention. The present invention may be embodied in other specific forms without departing from the essential characteristics thereof.

### REFERENCE SIGNS LIST

1 Pressure reducing valve
12 Valve seat
13 Body member
14 Valve element
16 Piston
17 Spring
19 First pressure-regulating chamber
21 Second pressure-regulating chamber
38 Passage
39 Spring seat
42 Retaining part
47 Polished surface
48 Recessed portion
61 Protrusion
62 Convex portion
63 Outer peripheral surface
64 Inner circumferential portion
66 Metal plate
67 Thick portion
69 Inlet
71 Protruding portion
72 Spring
76 Spring
G Fuel gas
L1 Central axis (of valve element)
L2 Central axis (of piston)
L11 Central axis (of end portion of valve element)
L12 Central axis (of inlet of first pressure-regulating chamber)

What is claimed is:

1. A pressure reducing valve comprising:
a valve seat;
a valve element configured to contact with and separate from the valve seat to close and open a flow passage;
a piston configured to cause the valve element to contact with and separate from the valve seat; and
a spring urging the piston in a valve opening direction of the valve element,
the pressure reducing valve being configured to regulate pressure of a fluid flowing in the flow passage,
wherein the pressure reducing valve further comprises a rattling prevention part configured to suppress rattling between the piston and the spring due to unevenness of an end face of the spring, the end face being located at one end in a central axis direction of the spring.

2. The pressure reducing valve of claim 1, wherein
the piston includes a contact portion contacting with the end face of the spring, and
the rattling prevention part includes a plurality of protrusions each protruding on the contact portion of the piston contacting with the end face of the spring, the protrusions being arranged at predetermined intervals in a circumferential direction of the spring.

3. The pressure reducing valve of claim 1, wherein the rattling prevention part is a flat plate fixed to the end face of the spring.

4. A pressure reducing valve comprising:
a valve seat;
a valve element configured to contact with and separate from the valve seat to close and open a flow passage;
a piston configured to cause the valve element to contact with and separate from the valve seat; and
a spring urging the piston in a valve opening direction of the valve element,
the pressure reducing valve being configured to regulate pressure of a fluid flowing in the flow passage,
wherein the piston and the spring are fixed to each other.

5. The pressure reducing valve of claim 4, wherein
the piston includes a contact portion contacting with the spring,
the piston is provided with a cylindrical protruding part protruding from the contact portion in a central axis direction of the spring, and
the piston and the spring are fixed to each other by press-fitting of an inner circumferential portion of the spring on an outer peripheral surface of the protruding part.

6. A pressure reducing valve comprising:
a valve seat;
a valve element configured to contact with and separate from the valve seat to close and open a flow passage;
a piston configured to cause the valve element to contact with and separate from the valve seat; and
a spring urging the piston in a valve opening direction of the valve element,
the pressure reducing valve being configured to regulate pressure of a fluid flowing in the flow passage,
wherein the pressure reducing valve further comprises:
a pressure-regulating chamber formed on a downstream side of the valve seat in a flow direction of a fluid so that pressure of the fluid is regulated in the pressure-regulating chamber; and
a flow-direction fixing part configured to fix a flow direction of the fluid to a predetermined fixed direction when the fluid flows in the pressure-regulating chamber.

7. The pressure reducing valve of claim 6, wherein
the flow-direction fixing part is the valve element placed integrally with the piston in the pressure-regulating chamber, and
the valve element has an asymmetric shape about a central axis of the valve element.

8. The pressure reducing valve of claim 7, wherein the valve element is provided with a thick portion in a part in a circumferential direction of the valve element.

9. The pressure reducing valve of claim 6, wherein
the flow-direction fixing part is the valve element placed integrally with the piston in the pressure-regulating chamber, and
the valve element includes an end portion on a side toward the valve seat so that a central axis of the end portion is displaced from a central axis of the pressure-regulating chamber in a radial direction of the pressure-regulating chamber.

10. The pressure reducing valve of claim 6, wherein the flow-direction fixing part is configured to restrict the valve element placed integrally with the piston in the pressure-regulating chamber from tilting to one side in a radial direction of the pressure-regulating chamber.

11. The pressure reducing valve of claim 10, wherein the flow-direction fixing part is a protruding portion protruding inward from an inner peripheral surface of the pressure-regulating chamber.

12. A pressure reducing valve comprising:
a valve seat;
a valve element configured to contact with and separate from the valve seat to close and open a flow passage;
a piston configured to cause the valve element to contact with and separate from the valve seat; and
a spring urging the piston in a valve opening direction of the valve element,
the pressure reducing valve being configured to regulate pressure of a fluid flowing in the flow passage,
wherein the valve element is integral with the piston, and
the pressure reducing valve further comprises a valve element urging member placed in a position displaced from a central axis of the valve element in a radial direction of the valve element and configured to urge a part of the valve element in its circumferential direction to a valve opening direction.

13. A pressure reducing valve comprising:
a valve seat;
a valve element configured to contact with and separate from the valve seat to close and open a flow passage;
a piston configured to cause the valve element to contact with and separate from the valve seat; and
a spring urging the piston in a valve opening direction of the valve element,
the pressure reducing valve being configured to regulate pressure of a fluid flowing in the flow passage,
wherein the pressure reducing valve further comprises a piston urging member placed in a position displaced from a central axis of the piston in a radial direction of the piston and configured to urge a part of the piston in its circumferential direction to a direction opposite to an urging direction of the spring.

14. The pressure reducing valve of claim 1, wherein a fluid having undergone pressure regulation flows in a direction of a central axis of the piston.

15. The pressure reducing valve of claim 4, wherein a fluid having undergone pressure regulation flows in a direction of a central axis of the piston.

16. The pressure reducing valve of claim 6, wherein a fluid having undergone pressure regulation flows in a direction of a central axis of the piston.

17. The pressure reducing valve of claim 12, wherein a fluid having undergone pressure regulation flows in a direction of a central axis of the piston.

18. The pressure reducing valve of claim 13, wherein a fluid having undergone pressure regulation flows in a direction of a central axis of the piston.
